(19) United States
(12) Patent Application Publication
(10) Pub. No.: US 2005/0159033 A1
(43) Pub. Date: Jul. 21, 2005

(54) Card connector having a stopper to be fixed to a mounting object and adapted to come in contact with a card inserted into the card connector

(75) Inventors: Keisuke Nakamura, Tokyo (JP); Akira Kimura, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Japan Aviation Electronics Industry, Limited, Tokyo (JP)

(21) Appl. No.: 11/037,424

(22) Filed: Jan. 18, 2005

(30) Foreign Application Priority Data
Jan. 19, 2004 (JP) 2004-11107

(51) Int. Cl. H01R 13/62

(52) U.S. Cl. 439/152

(57) ABSTRACT

In a card connector to be fixed to a mounting object and used for connecting a card, a stopper is coupled to an insulator holding a conductive contact. The stopper has a fixing portion to be fixed to the mounting object. Furthermore, the stopper has a butting portion to be engaged with the card in a predetermined direction when the card is inserted in the predetermined direction into a receiving portion defined by a cover coupled to the insulator.

This application claims priority to prior Japanese Patent Application JP 2004-11107, the disclosure of which is incorporated herein by reference.

### BACKGROUND OF THE INVENTION

This invention relates to a card connector for use in connecting a card.

In various types of apparatus and equipment such as a notebook-type personal computer, a PDA (personal digital assistant), and a digital camera, a card may be used for the purpose of function enhancement. In order to enable the card to be connected, the apparatus is provided with a card connector.

An existing card connector comprises an insulator, a contact held by the insulator, a cover, and an ejector slidably held by the cover. The ejector has a spring and continuously urges the card in a card ejecting direction.

Typically, the card connector is fixed to a mounting object, such as a printed board, to which the card connector is to be mounted. In this case, a soldering portion of the contact is soldered to the printed board.

When the card is inserted into the card connector, a forward end of the card is brought into contact with the insulator. Therefore, a load applied to the card is received by the contact. In the existing card connector, the soldering portion of the contact may be damaged if the load applied to the card is large.

### SUMMARY OF THE INVENTION

It is therefore an object of this invention to provide a card connector which is suppressed in possibility of damage upon a fixing structure with respect to a mounting object even if a load applied to a card is large.

Other objects of the present invention will become clear as the description proceeds.

According to an aspect of the present invention, there is provided a card connector to be fixed to a mounting object and used for connecting a card, the card connector comprising a contact being conductive, an insulator holding the contact, a cover coupled to the insulator and defining a receiving portion for receiving the card in a predetermined direction, and a stopper coupled to the insulator and having a fixing portion to be fixed to the mounting object, the stopper having a butting portion to be engaged with the card in the predetermined direction when the card is inserted into the receiving portion.

### BRIEF DESCRIPTION OF THE DRAWING

FIG. 1 is a perspective view of a card connector according to a first embodiment of this invention when a card is inserted;

FIG. 2 is a bottom perspective view of a characteristic part of the card connector in FIG. 1;

FIG. 3 is a bottom perspective view of the card connector in FIG. 1, showing a fixing structure between a stopper and a cover;

FIG. 4 is an exploded perspective view of the card connector in FIG. 1;

FIG. 5 is a perspective view of an ejector attached to the cover of the card connector in FIG. 1;

FIG. 6 is a perspective view of the card connector in FIG. 1 in a state where a card contacting portion of the ejector is brought into contact with a forward end of the card;

FIG. 7 is a top perspective view of a characteristic part of a card connector according to a second embodiment of this invention; and

FIG. 8 is a bottom perspective view of the characteristic part of the card connector in FIG. 7.

### DESCRIPTION OF THE PREFERRED EMBODIMENTS

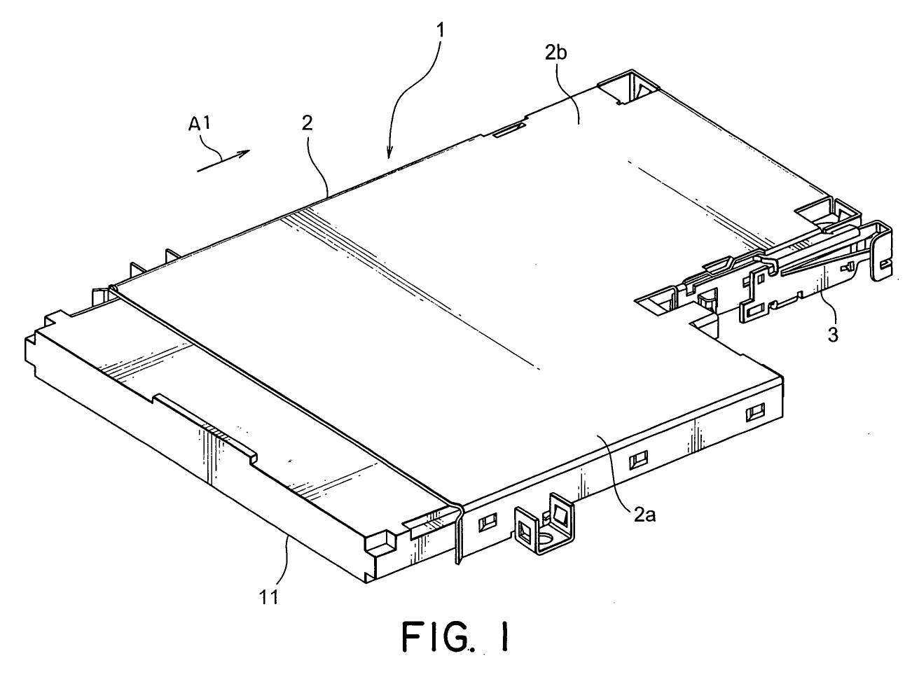

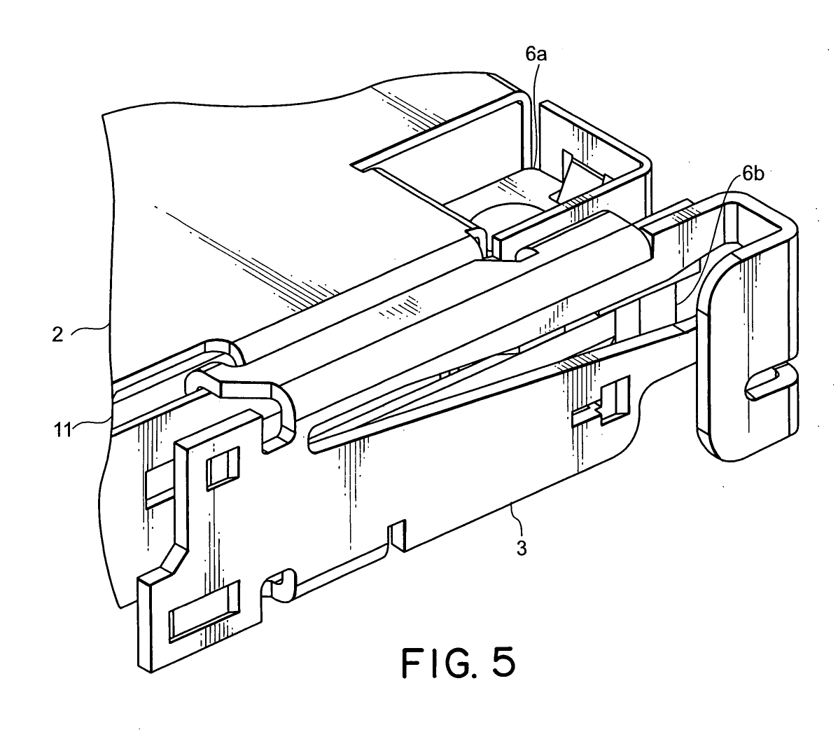

At first referring to FIGS. 1 to 6, description will be made of a card connector according to a first embodiment of this invention.

Referring to FIG. 1, a card 11 is inserted into the card connector depicted at 1 in the figure. The card connector 1 includes a cover 2 defining a card receiving portion. The cover 2 has a wide portion 2a and a narrow portion 2b. On a lateral side of the narrow portion 2b of the cover 2, an ejector 3 for ejecting the card 11 from the card connector 1 is arranged. The card 11 is analogous in shape to the cover 2.

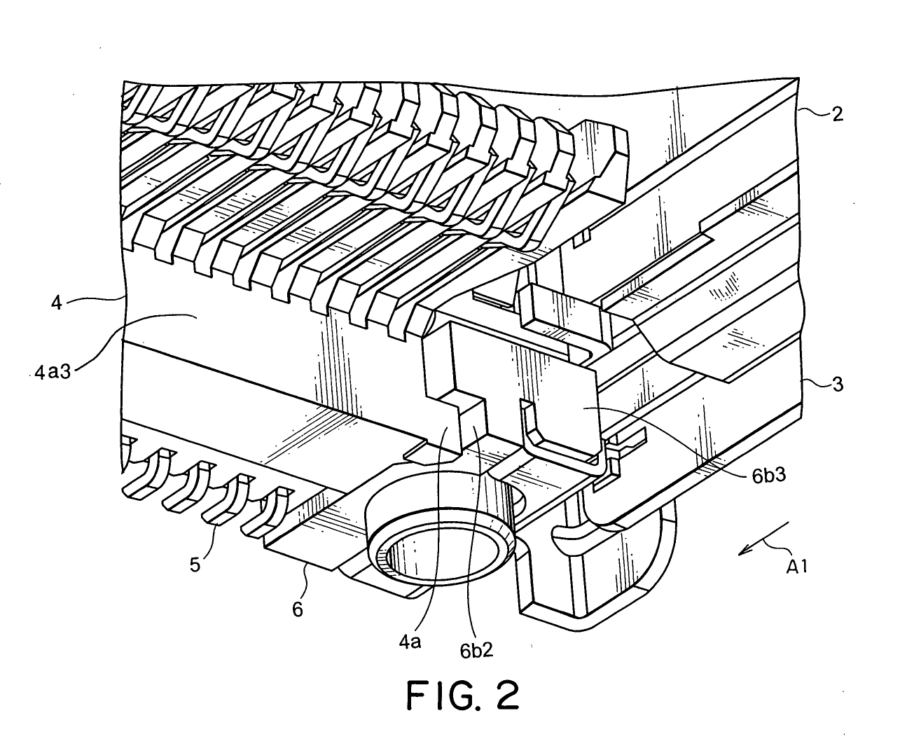

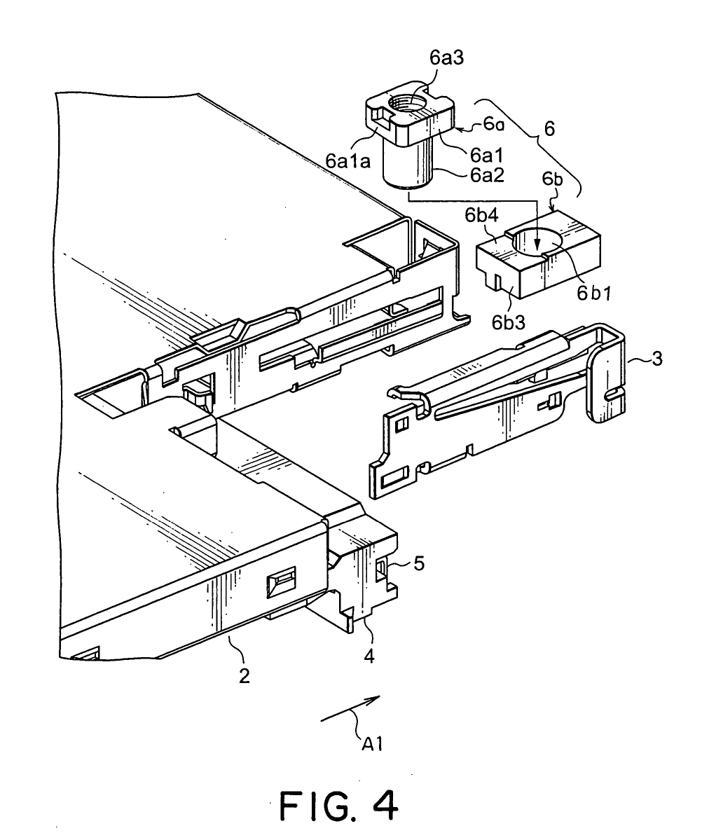

Referring to FIG. 2 together with FIG. 1, the card connector 1 has an insulator 4 holding a number of contacts 5 arranged in a single row at a predetermined pitch. A pair of stoppers 6 are arranged around opposite corners at an end of the narrow portion 2b of the cover 2. As shown in FIG. 4, each stopper 6 includes an inner stopper 6a and an outer stopper 6b coupled to the inner stopper 6a. The inner stopper 6a comprises a generally rectangular block 6a1 and a cylinder 6a2 fixed to the block 6a1. The outer stopper 6b is shaped into a generally rectangular block with a circular hole 6b1 to receive the cylinder 6a2 inserted therethrough. The outer stopper 6b has a recessed portion (engaging portion) 6b2 and a butting portion (butting surface) 6b3 to be engaged with a forward end of the card 11 in a predetermined direction A1 when the card 11 is inserted into the card connector 1 in the predetermined direction A1.

The inner stopper 6a is provided with a threaded hole 6a3. By screwing a screw through the threaded hole 6a3 into a printed board (not shown) or the like as a mounting object, the card connector 1 is fixed to the printed board or the like. The cylinder 6a2 is inserted into a hole formed on the printed board or the like to position the stopper 6 with respect to the printed board or the like.

The insulator 4 has protruding portions (engaged portions) 4a formed at opposite corners thereof. The protruding portions 4a are engaged with the recessed portions 6b2 of the outer stoppers 6b, respectively. Thus, the insulator 4 is fixed to the printed board through the stoppers 6.

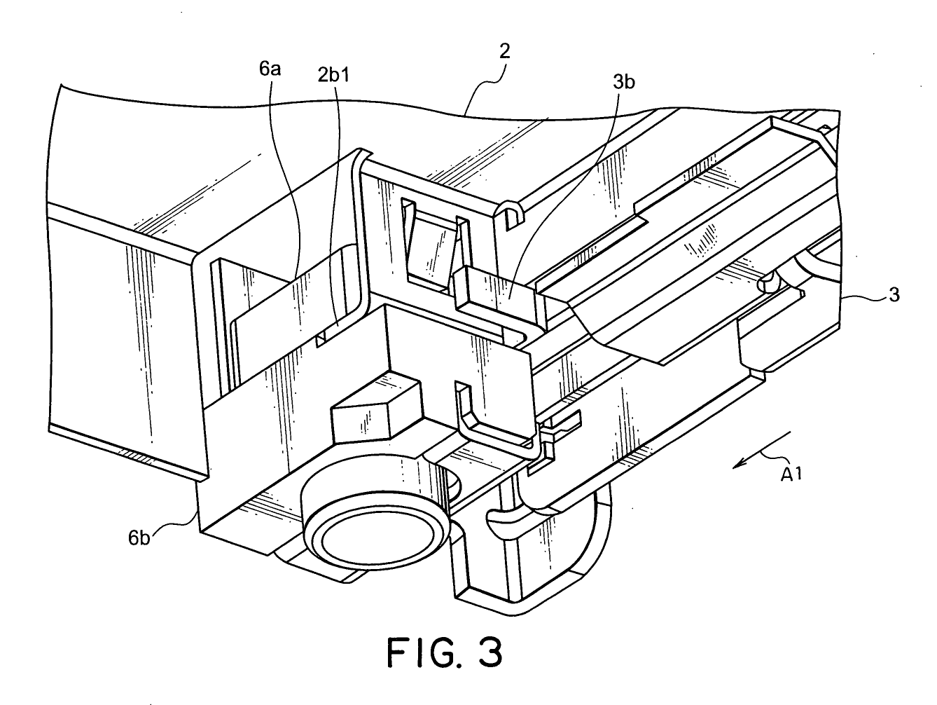

Referring to FIGS. 3 through 5, each of the outer stoppers 6b has a low-level portion 6b4 formed on its upper surface. Between the low-level portion 6b4 and the generally rectangular block 6a1 of the inner stopper 6a, a bent portion 2b1 of the narrow portion 2b of the cover 2 is clamped. With this structure, the cover 2 is prevented from undesirably floating or lifting up.

Description will be made of insertion and ejection of the card 11 into and from the card connector 1. The ejector 3 urges the card 11 by a coil spring (not shown) in a direction of ejecting the card 11 from the card connector 1.

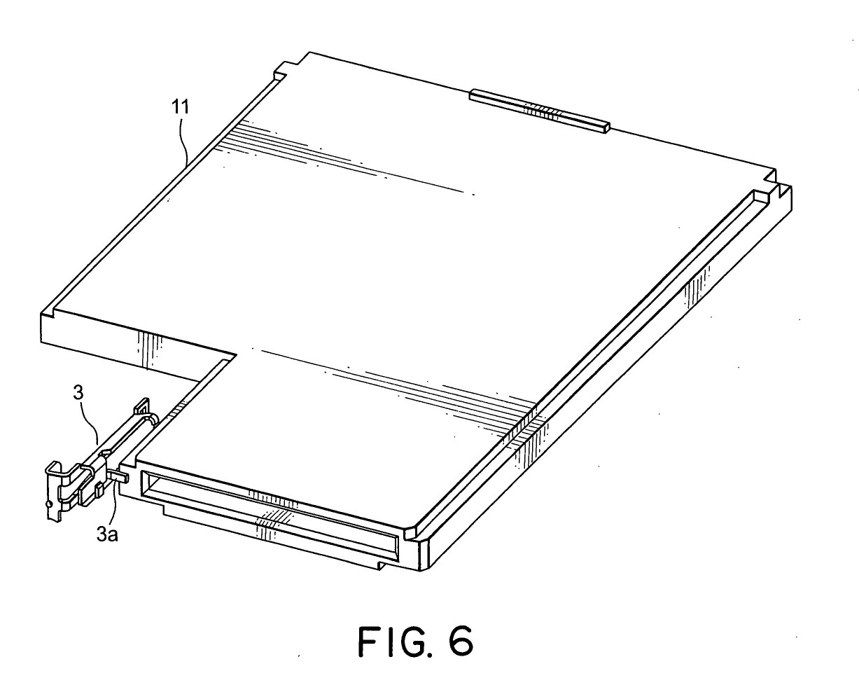

When the card 11 is inserted into the card connector 1, the forward end of the card 11 presses a card contacting portion 3a of the ejector 3 (see FIG. 6). The forward end of the card 11 is brought into contact with the butting portions 6b3 of the outer stoppers 6b. A protruding portion 3b of the ejector 3 is brought into contact with a contacting portion 6a1a of one of the inner stoppers 6a. Since a step is formed between the butting portion 6b3 and a bottom portion 4a3 of the insulator 4 (see FIG. 2), the forward end of the card 11 does not come into contact with the insulator 4. In this state, contact points of the card 11 are connected to the contacts 5 of the card connector 1, respectively. The ejector 3 is locked by a lock mechanism (not shown).

In order to eject the card 11 from the card connector 1, the lock mechanism is unlocked. Then, the card contacting portion 3a of the ejector 3 presses the forward end of the card 11 by a reactive force of the coil spring. As a consequence, the card 11 is ejected from the card connector 1.

With the card connector 1 mentioned above, the card 11 is brought into contact with the butting portions 6b3 of the stoppers 6 fixed to the mounting object. Therefore, even if the card 11 is subjected to a large load, the load is received by the stoppers 6 without adversely affecting soldering portions of the contacts 5. Further, the number of components is reduced so that the size of the card connector 1 can be reduced and the cost is saved.

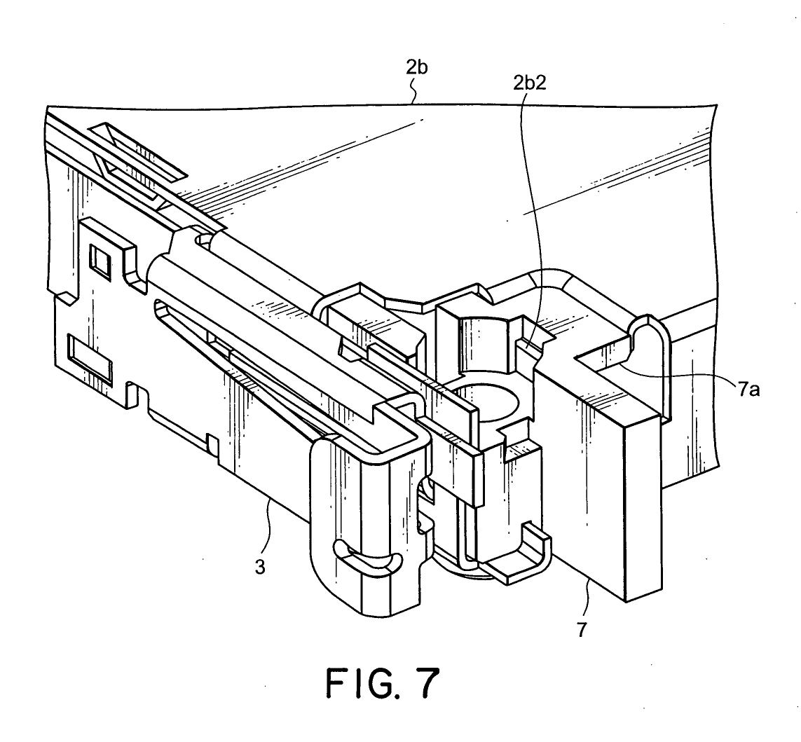

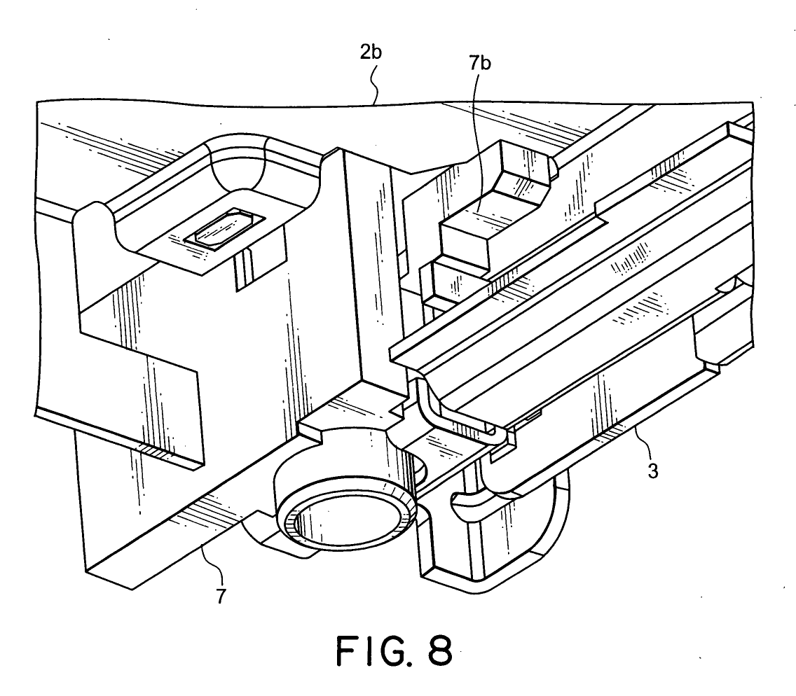

Referring to FIGS. 7 and 8, description will be made of a card connector according to a second embodiment of this invention. Similar parts are designated by like reference numerals and description thereof will be omitted.

In the card connector illustrated in FIGS. 1 through 6, each of the stoppers 6 comprises two components, i.e., the inner stopper 6a and the outer stopper 6b. On the other hand, in the card connector illustrated in FIGS. 7 and 8, a stopper 7 as a whole comprises a single element. The stopper 7 has a flange 7a formed at an upper part on one side thereof. A tongue-like portion 2b2 of the narrow portion 2b of the cover 2 is engaged with a lower side of the flange 7a to prevent the cover 2 from undesirably floating or lifting up.

The stopper 7 is provided with an overhanging portion 7b formed at an upper part on the other side. If the card 11 is forced upward (in a thickness direction of the card 11), an upper surface of the card 11 is brought into contact with the overhanging portion 7b to prevent the card 11 from moving upward. Also, the tongue-shaped portion 2b2 exhibits a function similar to that of the overhanging portion 7b.

In the foregoing description, both of the card and the ejector are brought into contact with the stopper. Alternatively, either one of the card and the ejector may be brought into contact with the stopper.

While this invention has thus far been described in connection with the preferred embodiments thereof, it will be readily possible for those skilled in the art to put this invention into practice in various other manners without departing from the scope set forth in the appended claims.

1. A card connector to be fixed to a mounting object and used for connecting a card, the card connector comprising:
a contact being conductive;
an insulator holding the contact;
a cover coupled to the insulator and defining a receiving portion for receiving the card in a predetermined direction; and
a stopper coupled to the insulator and having a fixing portion to be fixed to the mounting object, the stopper having a butting portion to be engaged with the card in the predetermined direction when the card is inserted into the receiving portion.

2. The card connector according to claim 1, wherein the insulator has an engaged portion, the stopper having an engaging portion, the engaged portion and the engaging portion being engaged with each other so that the insulator is fixed to the mounting object through the stopper.

3. The card connector according to claim 1, wherein the stopper has an overhanging portion for preventing the card from moving in a thickness direction of the card.

4. The card connector according to claim 1, wherein the cover has a tongue-like portion engaged with the stopper to prevent the card from moving in a thickness direction of the card.

5. The card connector according to claim 1, further comprising an ejector movable with the card, the ejector being brought into contact with the butting portion of the stopper when the card is inserted into the receiving portion.

6. The card connector according to claim 1, wherein the mounting object has a hole, the stopper having a cylinder to be inserted into the hole of the mounting object, the cylinder being inserted into the hole of the mounting object to position the stopper.

7. The card connector according to claim 6, wherein the stopper comprises:
an inner stopper including the cylinder and a block fixed to one end of the cylinder; and
an outer stopper having a hole for receiving the cylinder inserted therethrough and faced to the block.

8. The card connector according to claim 7, wherein the cylinder is inserted into the hole of the mounting object through the hole of the outer stopper.

9. The card connector according to claim 6, wherein the stopper is formed by a single element.

10. The card connector according to claim 9, wherein the stopper has a flange engaged with the cover.

11. The card connector according to claim 10, wherein the cover has a tongue-shaped portion engaged with the flange.
